(19) United States
(12) Patent Application Publication
(10) Pub. No.: US 2007/0163627 A1
(43) Pub. Date: Jul. 19, 2007

(54) Nozzle for substrate treatment apparatus

(76) Inventors: Pyoung-Ho Lim, Hwaseong-si (KR); Jong-Kook Song, Yongin-si (KR); Han-Mil Kim, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/653,262

(22) Filed: Jan. 16, 2007

(30) Foreign Application Priority Data
Jan. 16, 2006 (KR) 2006-004432

(51) Int. Cl. B08B 3/00; B05B 15/00; A62C 37/20

(52) U.S. Cl. 134/94.1; 134/103.2; 239/76; 239/553; 239/556; 239/562; 239/566; 239/567

(57) ABSTRACT

Provided are a nozzle and a related substrate treatment apparatus. The substrate treatment apparatus includes a process chamber, a supporting member disposed in the process chamber to support substrates, and a nozzle disposed in the process chamber to supply treatment fluid. The nozzle includes an outer tube along which a plurality of spraying holes are formed and which has a first end that is closed and an inner tube inserted into the outer tube through a hole formed on a second end of the outer tube.

### BACKGROUND OF THE INVENTION

1. Field of the Invention

Embodiments of the invention relate to a nozzle adapted for use in a substrate treatment apparatus. More particularly, embodiments of the invention relate to a fluid spraying nozzle useful in a substrate treatment apparatus adapted to clean substrates.

This U.S. non-provisional patent application claims priority under 35 U.S.C. § 119 of Korean Patent Application No. 2006-004432 filed on Jan. 16, 2006, the contents of which are hereby incorporated by reference.

2. Discussion of Related Art

Semiconductor devices are manufactured by iteratively performing a variety of fabrication processes, such as a deposition, photolithography, etching, polishing, and cleaning processes. Various cleaning processes are performed to remove residual chemicals, small particles, contaminants, or undesired material layers from the working surface of the substrate. Cleaning processes are performed at multiple points during the fabrication of semiconductor devices. The positive influence of various cleaning processes on the ultimately successful fabrication of semiconductor devices has become even more pronounced as the circuit patterns used to form contemporary semiconductor devices become ever more fine.

Many conventional cleaning processes are characterized by the application of one or more solutions adapted to chemically etch or delaminate contaminants from the working surface of the substrate. Application of such solutions is commonly followed by a rinsing the substrate in a neutral agent, such as deionized water. After rinsing, the substrate is dried in specially controlled drying processes.

Substrate cleaning apparatuses may be classified as single-wafer type and batch type. In a single-wafer type apparatus, the substrate cleaning process is performed by applying cleaning solution to a horizontally oriented wafer (i.e., a wafer oriented so that its working surface is upward facing). In a batch type apparatus, the substrate cleaning process is performed by dipping a plurality of vertically oriented wafers (i.e., a plurality of wafers oriented so that their working surfaces are laterally facing). In the description that follows, the terms “wafer” and “substrate” may be viewed as equivalents, since substrates are formed on wafers and wafers provided substrates. This having been said many different types of substrates formed on many different types and shapes of wafers are contemplated by the present invention.

Other batch type apparatuses include a nozzle adapted to spray cleaning solution (e.g., a specific chemical solution or a cleaning liquid) into a treatment chamber in which a plurality of wafers has been previously loaded. Figure (FIG.) 1 shows a conventional nozzle adapted for use in such a batch type apparatus. A nozzle 900 is formed from a single hollow tube having a closed end 904. A plurality of spraying holes 902 are formed along the length of nozzle 900 and are adapted to spray cleaning solution into a treatment chamber.

Unfortunately, the constricted nature (e.g., the bent fluid path “A”) of closed end 904 causes cleaning solution flowing through nozzle 900 to build up against the opposing wall of closed end 904. That is, the cleaning solution partially reverses flow against the opposing wall creating surging turbulence and/or pressure. Such surging turbulence and uneven flow pressure causes mechanical vibration in or around nozzle 900. Such vibration may cause the damage to nozzle 900 or mechanical assemblies used to secure nozzle 900.

Additionally, because of the uneven flow pressure and surging phenomenon, a relatively large amount of cleaning solution is sprayed through the spraying holes 902 proximate closed end area A. Since the amount of cleaning solution applied to a wafer effects the overall cleaning ability of the process being performed, the uneven application of cleaning solution in this manner leads to uncontrolled results and deteriorated working surfaces. In particular, when the cleaning solution being applied is a chemical solution, and since a relatively large amount of the chemical solution is sprayed onto portions of a wafer near the closed end of nozzle 900, these wafer portions may become over-etched. Over-etching results in process errors.

In addition, in batch type apparatuses, the plurality of wafers is typically supported by a supporting member having a plurality of slots, each slot being adapted to receive the edge of a single wafer. In this case, since a relatively large amount of the cleaning solution is sprayed onto the wafers near the closed end of nozzle 90, such wafers may actually become dislodged from their slot under the impact of the applied cleaning solution.

The above-described problems may be more severe when a relatively large amount of the cleaning solution is required for a particular cleaning process.

### SUMMARY OF THE INVENTION

Embodiments of the invention provide a nozzle adapted to reduce the uneven application of a cleaning solution.

Embodiments of the invention also provide a substrate treatment apparatus providing, greater cleaning uniformity between wafers in a batch of wafers.

Embodiments of the invention also provide a nozzle adapted not to damage wafers due to the surging phenomenon, and further adapted not to induce potentially damaging mechanical vibrations.

In one embodiment, the invention provides a substrate treatment apparatus comprising; a process chamber, a supporting member disposed in the process chamber and adapted to support wafers forming substrates, and a nozzle disposed in the process chamber and adapted to supply treatment solution. The nozzle comprises an outer tube comprising a plurality of spraying holes and a closed first end and an opposing second end, and an inner tube adapted to receive a flow of treatment solution and inserted into the outer tube through the second end of the outer tube.

In another embodiment, the invention provides a nozzle comprising; an inner tube adapted to receive a flow of treatment solution at a proximate end and pass the treatment solution in a first direction from an open distal end, and an outer tube having a closed first end facing and proximate to the distal end of the inner tube, the outer tube enclosing the inner tube and being provided with a plurality of spraying holes formed along the length of the outer tube, wherein treatment solution passing from the inner tube collides with the first end of the outer tube and back-flows into a space between the inner and outer tubes in a second direction opposite the first direction.

In another embodiment, the invention provides a nozzle comprising; a plurality of tubes, wherein a treatment solution is introduced through an inner most tube amongst the plurality of tubes, the treatment solution passes from the innermost tube to collide with a sidewall of an intermediate tube enclosing the innermost tube to cause back-flowing of the treatment solution through a space between the innermost tube and the intermediate tube, and an outermost tube comprises a plurality of spraying holes adapted to spray the treatment solution at a substantially uniform discharge flow.

### BRIEF DESCRIPTION OF THE DRAWINGS

Non-limiting and non-exhaustive embodiments of the present invention will be described with reference to the attached figures, wherein like reference numerals refer to like parts throughout the various figures unless otherwise specified. In the drawings, certain dimensions and geometric regions may have been exaggerated for clarity of illustration. In the drawings:

FIG. 1 is a sectional view a conventional nozzle of a substrate cleaning apparatus;

FIG. 2 is a schematic view of a substrate treatment apparatus according to an embodiment of the present invention;

FIG. 3 is a perspective view of a supporting member depicted in FIG. 2;

FIG. 4 is a perspective view of a nozzle depicted in FIG. 2, according to an embodiment of the present invention;

FIG. 5 is a sectional view taken along line I-I of FIG. 4;

FIG. 6 is a view illustrating a flow path of cleaning solution supplied to the nozzle depicted in FIG. 4;

FIGS. 7 and 8 are views illustrating an operational difference between the nozzle depicted in FIG. 1 and the nozzle depicted in FIG. 4;

FIGS. 9 and 10 are perspective views of modified examples of the nozzle depicted in FIG. 5; and

FIG. 11 is a sectional view of another modified example of the nozzle depicted in FIG. 5.

### DESCRIPTION OF EMBODIMENTS

Embodiments of the invention will now be described in some additional detail with reference to the accompanying drawings. The present invention may, however, be embodied in different forms and should not be constructed as limited to only the embodiments set forth herein. Rather, these embodiments are provided as teaching examples. Hereinafter, it will be described about an exemplary embodiment of the present invention in conjunction with the accompanying drawings.

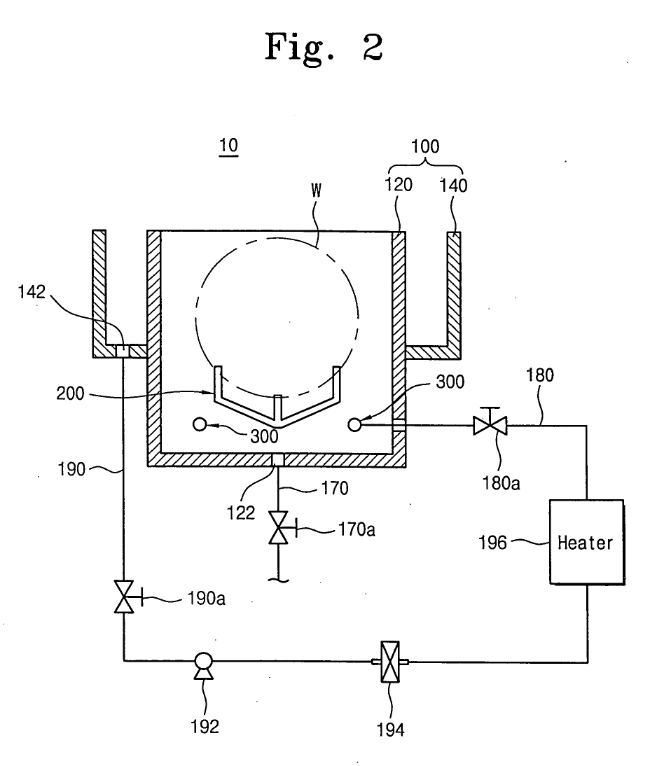

FIG. 2 is a schematic view of a substrate treatment apparatus according to an embodiment of the present invention. In this embodiment, a cleaning apparatus adapted to perform a cleaning process on a plurality of wafers is illustrated as a substrate treatment apparatus 10. Referring to FIG. 2, substrate treatment apparatus 10 comprises a process chamber 100, a supporting member 200 and a fluid supplying member 300. Process chamber 100 provides a space in which the wafers W are loaded and processed. Supporting member 200 supports the wafers W in process chamber 100. Fluid supplying member 300 supplies fluid to process chamber 100.

For example, the supplied fluid may be chemical solution such as phosphoric acid, sulfuric acid, or ammonium hydration, and the like which are commonly used to remove contaminants, undesired material layers, organic matter, and particles from the wafers W. Alternatively, the supplied fluid may be cleaning liquid such as deionized water used to remove and/or neutralize a previously applied chemical solution. Alternatively, the supplied fluid may be inert gas or alcohol vapor, such as isopropyl alcohol vapor, used to dry the wafers W.

In the following description, a case where a chemical liquid is applied to remove undesired material layers from the wafers W will be used as an example. In this example, the undesired material layer is assumed to be a nitride layer and the chemical liquid is assumed to be a phosphoric acid solution. The exemplary substrate treatment apparatus 10 will now be described in some additional detail under these assumptions.

Process chamber 100 comprises an inner bath 120 having an open upper end and an outer bath 120 adapted to receive inner bath 120 in order to capture treatment solution overflowing inner bath 120. Inner bath 120 may be provided with an outlet 122 located near its bottom. Outlet 122 allows treatment solution to be exhausted from inner bath 120. A drain tube 170 having a drain valve 170a is connected to outlet 122 of inner bath 120. Near the bottom of outer bath 140 an outlet 142 is provided to exhaust treatment solution from outer bath 140. A drain tube 190 having a drain valve 190a is connected to outlet 142 of outer bath 140.

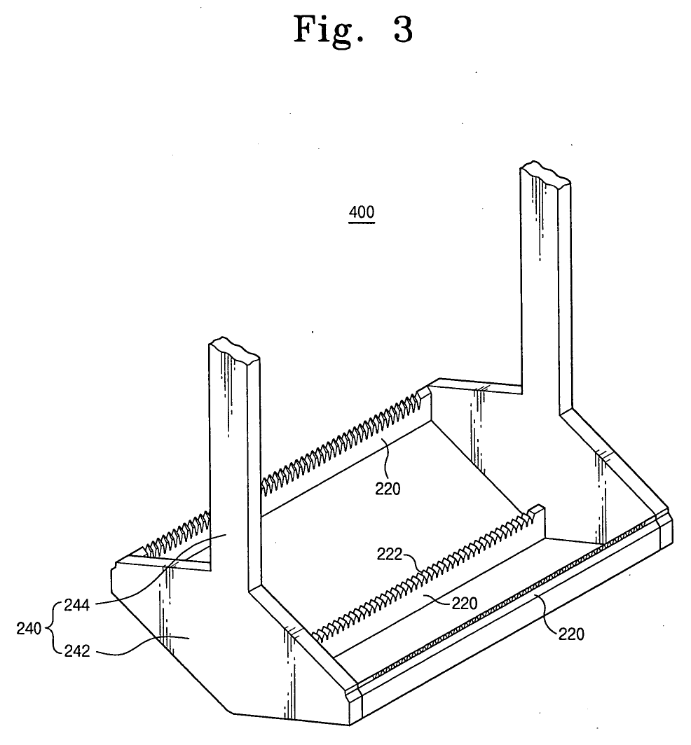

Supporting member 200 is adapted to support the wafers W during the cleaning process and is disposed in inner bath 120. Referring to FIG. 3, supporting member 200 may comprise a plurality of supporting rods 220 and side plates 240. Supporting rods 220 are provided with slots 222 into which the edges of wafers W may be inserted. During the cleaning process, the wafers W are typically racked onto supporting member 200 in parallel arrangement defined by slots 222. The number of supporting rods 220 may be three and about 50 wafers W may be supported on supporting rods 220. Side plates 240 are disposed on opposite ends of supporting rods 220 to secure supporting rods 220. Each side plate 240 may include a connecting portion 242 to which corresponding ends of supporting rods 220 may be fixedly and a fixing portion 244 extending upward from side plate 240 to be fixed within process chamber 100. Alternatively, supporting member 200 may not be fixed within process chamber 100, but may be vertically inserted into process chamber 100 by a driving unit (not shown).

With reference to FIG. 2, fluid supplying member 300 supplies treatment solution into inner bath 120. Fluid supplying member 300 comprises a nozzle 300 and a supplying tube 180. In one embodiment, one or more nozzle(s) 300 is disposed within process chamber 100 in a direction parallel to the arrangement direction of the wafers W (i.e., the parallel orientation of wafers defined by slots 222). In the illustrated example, nozzle 300 is disposed below supporting member 200.

When more than two nozzles 300 are provided, nozzles 300 may be arranged in parallel. Fluid supply tube 180 is disposed to one side of process chamber 100 and supplies treatment solution to nozzle(s) 300. An on/off valve 180a may be used to selectively control the flow of fluid through fluid supplying tube 180.

In one embodiment, fluid supplying tube 180 may be connected to drain tube 190 to re-circulate treatment solution exhausted from outer bath 140. A pump 192, a filter 194, and a heater 196 may be installed along the length of drain tube 190 and/or fluid supplying tube 180 to prepare the treatment solution for reuses. Pump 192 provides a defined flow pressure sufficient to circulate the treatment solution. Filter 194 filters foreign debris and contaminates from the treatment solution. Heater 195 ensures that the treatment solution is maintained within inner bath 120 at a predetermined process temperature. In addition, a distribution tube (not shown) for supplying a treatment solution reservoir (not shown) to fluid supplying tube 180 may be connected to fluid supplying tube 180.

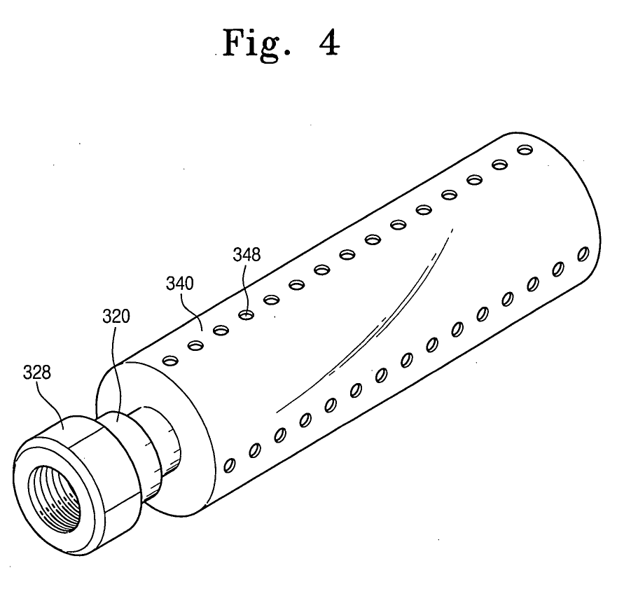

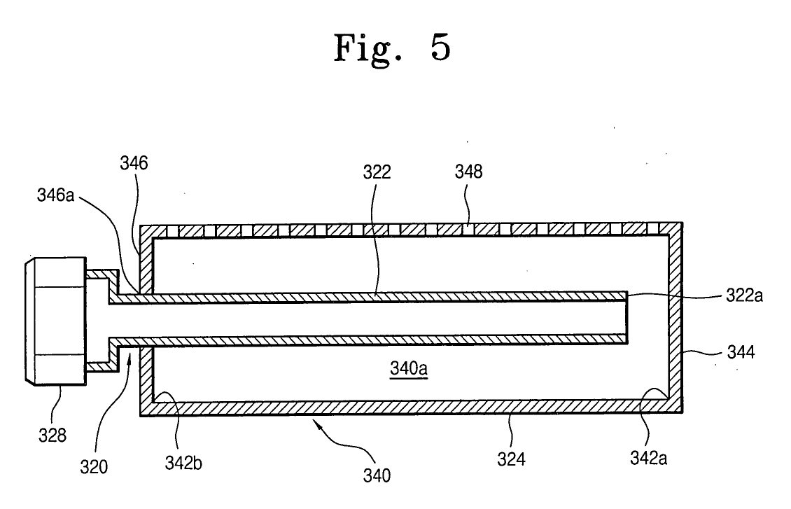

FIG. 4 is a perspective view of one exemplary nozzle adapted for use in the example shown in FIG. 2. Further, according to this particular embodiment of the present invention, FIG. 5 is a cross sectional view taken along line I-I of FIG. 4.

Referring to FIGS. 4 and 5, nozzle 300 comprises an inner tube 320 and an outer tube 340. Inner tube 320 has a tubular shaped body 322 with an open end opposing a fluid introduction port 328. Port 328 is adapted for connection to fluid supplying tube 180. Inner tube 320 may be inserted laterally into inner bath 120 through a hole (not shown) formed in a sidewall of inner bath 120. Outer tube 340 has a tubular shaped body 342 terminated in first and second ends 342a and 342b. A first lateral sidewall 344 forms first end 342a of tube body 342 opposite port 328. A second lateral sidewall 346 forms second end 342b and includes a central hole 346a through which inner tube 320 is inserted.

An inner diameter of tube body 324 of outer tube 340 is greater than the outer diameter of tube body 322 of inner tube 320, such that a space 340a is provided between inner tube 320 and outer tube 340. A plurality of spraying holes 348 are formed along a length of outer tube 340. Each spraying hole 348 may be formed with a circular shape. The spraying holes 348 may be arranged in a line, a plurality of lines, or a geometric array.

Outer tube 340 should have sufficient length to spray treatment solution on all of the wafers W. For example, fifty wafers may be loaded on supporting member 200. If the wafers are consecutively denoted as first, second, third, . . . , fiftieth wafers (i.e., W₁, W₂, W₃, . . . , W₅₀) starting from the foremost wafer W₁, outer tube 340 should extend such that first end 342a is positioned proximate the fiftieth wafer W₅₀ while second end 342b is positioned proximate the first wafer W₁. With this configuration, inner tube 320 will extend such its distal end 322a will be positioned proximate first end 342a of outer tube 340.

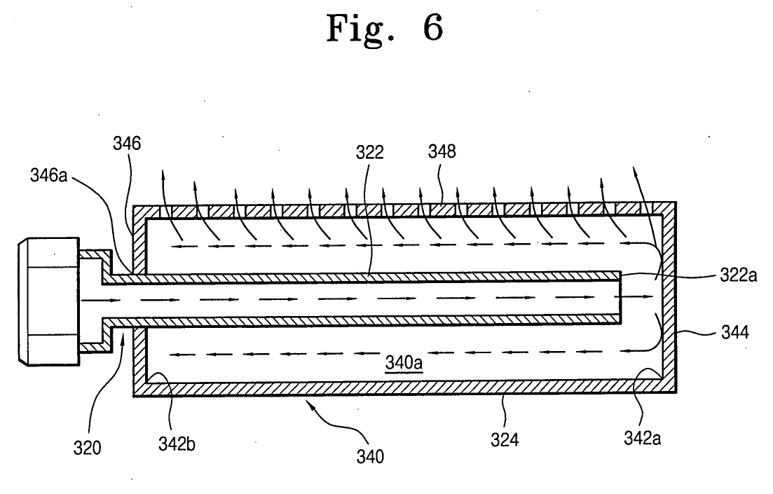

FIG. 6 illustrates a flow path for treatment solution supplied to nozzle 300. The treatment solution flows from fluid supplying tube 180 into inner tube 320. Then, the treatment solution passes from inner tube 320 distal open end 322a of inner tube 320. As the fluid passes from inner tube 320 it collides with sidewall 344 forming first end 342a of outer tube 340. The treatment solution then flows through space 340a between inner and outer tubes 320 and 340. The treatment solution essentially flows from first end 342a of outer tube 340 back towards second end 342b. This flow direction is opposite to that in inner tube 320. Most of the treatment solution is sprayed from nozzle 300 through spraying holes 348 provided in outer tube 340 while flowing through space 340a. The treatment solution reaching the second end 342b of outer tube 340 collides with sidewall 346 forming second end 342b of outer tube 340.

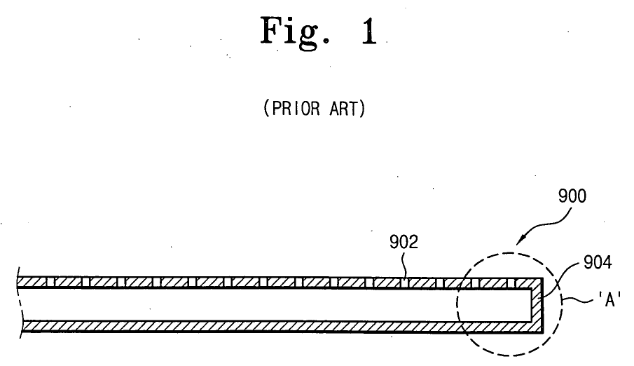

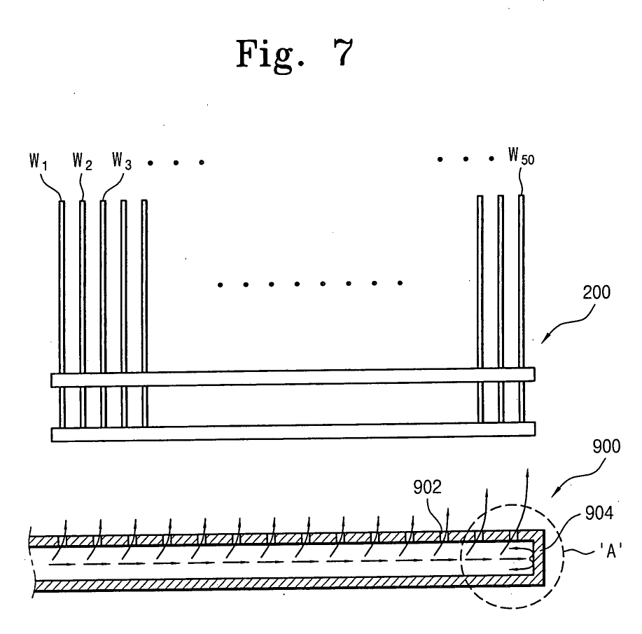

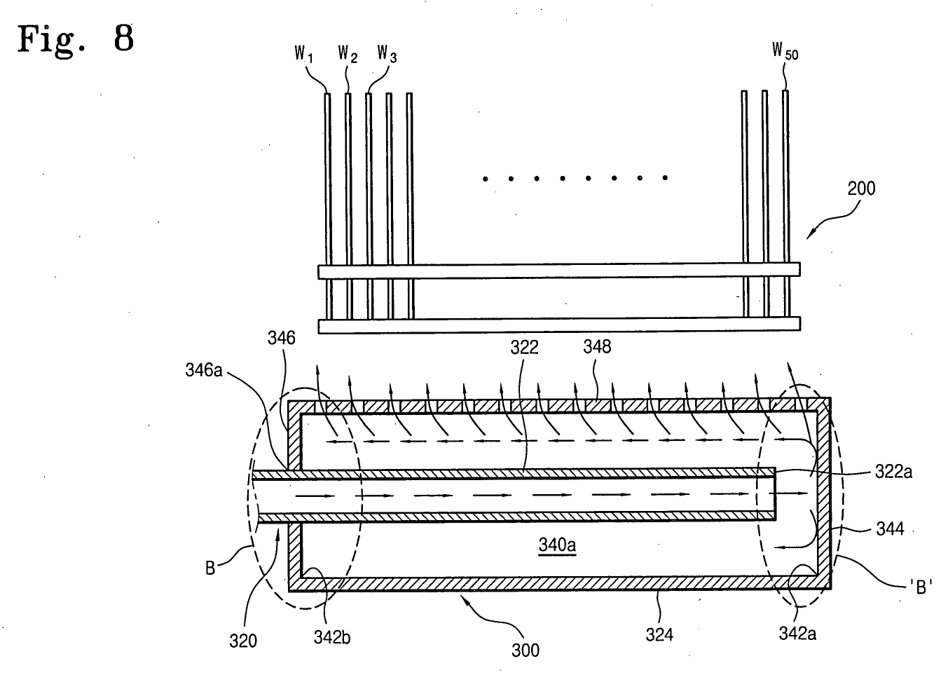

FIGS. 7 and 8 illustrate an operational difference between the nozzle depicted in FIG. 1 and the nozzle depicted in FIG. 4. The relative amount of treatment solution discharged from individual spraying holes is indicated in FIGS. 7 and 8 by the lengths of the illustrated arrows. As shown in FIG. 1, when nozzle 900 is formed from a single bent tube, a relatively large amount of the treatment solution is discharged through the distal end of nozzle 900. The surging treatment solution supplied by this conventional configuration back-flows in a reverse direction as it collides with wall of closed end 904 with all the disadvantages previously noted. That is, the fiftieth wafer W₅₀ proximate distal end 904 may well become over-etched in the working example. At a minimum, the wafers close to wafer W₅₀ will almost certainly be more greatly etched than wafers close to wafer W₁.

However, as shown in FIG. 8, when nozzle 300 is formed with a dual-tube configuration similar to that illustrated in FIG. 5, for example, the treatment solution passing from inner tube 320 first collides with sidewall 344 forming first end 342a of outer tube 340, after which, the treatment solution flows in a reverse direction through space 340a between the inner and outer tubes 320 and 340. This arrangement dramatically reduces the surging phenomenon in the region ‘B’ proximate first end 342a of outer tube 340. In addition, while the treatment solution flows from first end 342a of outer tube 340 to second end 342b of outer tube 340, a portion of the treatment solution is discharged through spraying holes 348 provided on outer tube 340. The residual treatment solution in space 340a collides with sidewall 346 forming second end 342b of outer tube 340. At this point, although the surging phenomenon may occur at an area B proximate second end 342b of outer tube 340, the degree of the surging phenomenon is not severe as substantial back-flow surging pressure has been substantially reduced by all of the foregoing.

When the single tube nozzle 900 is used, the surging phenomenon is concentrated on the area A near the extreme end of the nozzle 900. However, in the dual-tube nozzle 900 of the present invention, the surging phenomenon is distributed at both of the areas B and C near the opposite ends 342a and 342b of the nozzle 300. Therefore, the impact applied to the nozzle 300 and the spraying amount of the treatment solution at the opposite ends of the nozzle 300 can be reduced.

As described above, a relatively large amount of the treatment solution may yet be sprayed through spraying holes 348 proximate both first and second ends 342a and 342b of outer tube 340. (Note end arrows in FIG. 8). In view of this reality, the individual opening size and/or density of spraying holes 348 may be adjusted along the length of outer tube 340, such that treatment solution may be uniformly applied through all of the spraying holes 348.

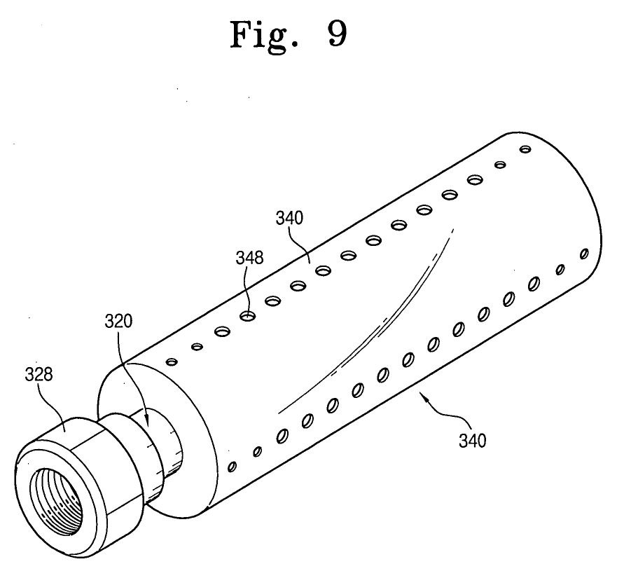

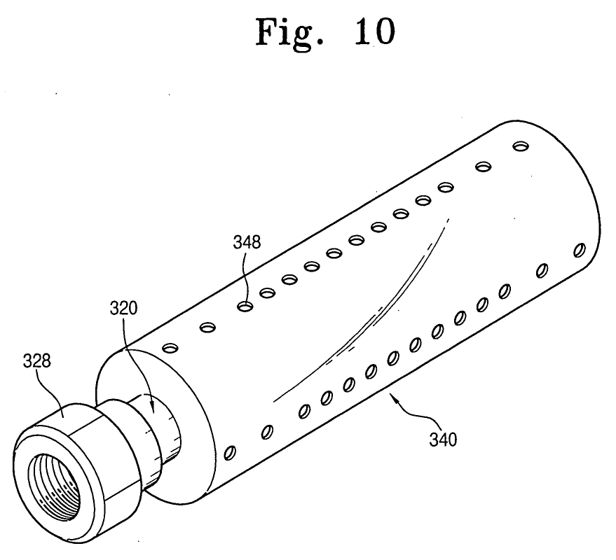

For example, the opening size and/or density of spraying holes 348 formed proximate first and second ends 342a and 342b of outer tube 340 may be smaller (or less dense) than other spraying holes 348 formed in a middle region of outer tube 340. A variable spraying hole size embodiment is illustrated in FIG. 9. A variable spraying hole density is illustrated in FIG. 10. Exact opening sizes and/or separating distances between adjacent spraying holes 348 may be set through a simulation test or trial and error.

In the foregoing embodiments, a dual tube nozzle is illustrated as an example. However, the present invention is not limited to only this case. For example, a triple-tube nozzle might serve well in various embodiments.

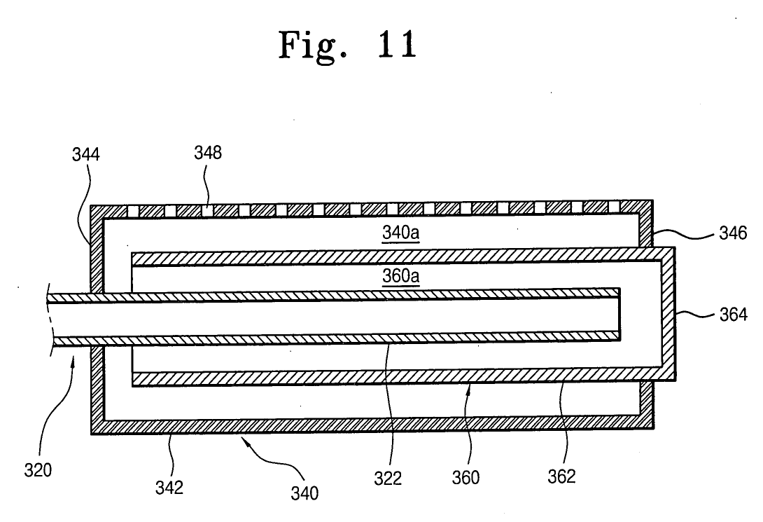

FIG. 11 shows an example of a triple-tube nozzle. Referring to FIG. 11, nozzle 300 includes an inner tube 320, an intermediate tube 360, and an outer tube 340. Inner tube 320 has a tube body 322 having an open distal end. Intermediate tube 360 has a tube body 362 having an open proximate end and a closed distal end formed by sidewall 364. (The terms distal and proximate in this context refer to the point of fluid introduction, but may be variously defined). Tube body 362 encloses inner tube 320 and sidewall 364 of intermediate tube 360 is disposed to face the distal end of inner tube 320 passing treatment solution. The treatment solution exhausted from inner tube 320 collides with sidewall 364 of intermediate tube 360 and back-flows through space 360a between the inner and intermediate tubes 320 and 360. Outer tube 340 includes a tube body 342 having closed first and second ends formed by sidewalls 346 and 344 respectively. A plurality of spraying holes 348 are formed along a length of outer tube 340. The treatment solution discharged from intermediate tube 360 collides with sidewall 344 of outer tube 340 and flows through a space between intermediate and outer tubes 360 and 340, in the course of which a portion of the treatment solution is sprayed through spraying holes 348. The rest of the treatment solution collides with sidewall 346 of outer tube 340.

In this embodiment, although a case where the nozzle 300 is used for the cleaning process is exampled, the present invention is not limited to this case. That is, nozzle 300 may be used for other processes.

In addition, nozzle 300 has been assumed to be disposed at a lower portion in the process chamber to spray the treatment solution toward the wafers. However, the present invention is not limited to this case. For example, nozzle 300 may be disposed at an upper portion in the process chamber to spray chemical liquid, deionized water, cleaning liquid, or drying gas such as inert gas or alcohol vapor.

According to the present invention, a difference between a spraying pressure of treatment solution discharged proximate a distal end of the nozzle and the spraying pressure of treatment solution discharged from a middle region of the nozzle may be reduced.

In addition, the cleaning efficiency and cleaning uniformity between the wafers in the batch type apparatus may be improved.

Furthermore, the degree of the surging phenomenon occurring at respective ends of the nozzle may be reduced, thereby preventing the nozzles and/or wafers from being damaged.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited to only the foregoing detailed description.

What is claimed is:

1. A substrate treatment apparatus comprising:
a process chamber;
a supporting member disposed in the process chamber and adapted to support wafers forming substrates; and
a nozzle disposed in the process chamber and adapted to supply treatment solution, wherein the nozzle comprises:
an outer tube comprising a plurality of spraying holes and a closed first end and an opposing second end; and
an inner tube adapted to receive a flow of treatment solution and inserted into the outer tube through the second end of the outer tube.

2. The apparatus of claim 1, wherein the inner and outer tubes are arranged such that the treatment solution passing from the inner tube collides with the first end of the outer tube and back-flows along a space between the inner and outer tubes.

3. The apparatus of claim 2, wherein the density of the plurality of spraying holes varies along the length of the outer tube.

4. The apparatus of claim 3, wherein a relatively less dense arrangement of spraying holes is disposed at ends of the outer tube as compared with a middle portion of the outer tube.

5. The apparatus of claim 2, wherein opening sizes for holes in the plurality of holes varies along the length of the outer tube.

6. The apparatus of claim 5, wherein opening sizes for holes in the plurality of holes disposed at ends of the outer tube are smaller than opening sizes for holes in the plurality of holes at a middle portion of the outer tube.

7. The apparatus of claim 1, wherein the treatment solution is cleaning liquid adapted to clean the substrates.

8. The apparatus of claim 1, wherein the wafers are racked on the supporting member in parallel and the nozzle is arranged in relation to a direction in which the substrates are racked.

9. The apparatus of claim 8, wherein the nozzle is disposed below the supporting member.

10. The apparatus of claim 2, wherein the inner and outer tubes each have a tubular rod shape.

11. A nozzle comprising:
an inner tube adapted to receive a flow of treatment solution at a proximate end and pass the treatment solution in a first direction from an open distal end; and
an outer tube having a closed first end facing and proximate to the distal end of the inner tube, the outer tube enclosing the inner tube and being provided with a plurality of spraying holes formed along the length of the outer tube,
wherein treatment solution passing from the inner tube collides with the first end of the outer tube and back-flows into a space between the inner and outer tubes in a second direction opposite the first direction.

12. The nozzle of claim 11, wherein the density of the plurality of spraying holes varies along the length of the outer tube.

13. The nozzle of claim 12, wherein a relatively less dense arrangement of spraying holes is disposed at ends of the outer tube as compared with a middle portion of the outer tube.

14. The nozzle of claim 11, wherein opening sizes for holes in the plurality of holes varies along the length of the outer tube.

15. The nozzle of claim 5, wherein opening sizes for holes in the plurality of holes disposed at ends of the outer tube are smaller than opening sizes for holes in the plurality of holes at a middle portion of the outer tube.

16. The nozzle of claim 11, wherein the treatment solution is cleaning liquid adapted to clean the substrates.

17. A nozzle comprising:
a plurality of tubes, wherein a treatment solution is introduced through an inner most tube among the plurality of tubes, the treatment solution passes from the innermost tube to collide with a sidewall of an intermediate tube enclosing the innermost tube to cause back-flowing of the treatment solution through a space between the innermost tube and the intermediate tube, and an outermost tube comprises a plurality of spraying holes adapted to spray the treatment solution at a substantially uniform discharge flows.

18. The nozzle of claim 17, wherein the nozzle comprises three tubes.
